(19) United States
(12) Patent Application Publication
(10) Pub. No.: US 2024/0030742 A1
(43) Pub. Date: Jan. 25, 2024

(54) A CONTROL SYSTEM AND METHOD FOR CONTROLLING A MICRO-GRID

(71) Applicant: Enapter S.r.l., Pisa (IT)

(72) Inventors: Sean Crawford CHAPMAN, Pisa (IT); Jan-Justus SCHMIDT, Pisa (IT); Nikolay V. KRASKO, Saint-Petersburg (RU); Nikita AFANASENKO, Saint-Petersburg (RU)

(21) Appl. No.: 18/257,418

(22) PCT Filed: Dec. 15, 2021
(86) PCT No.: PCT/EP2021/086027

§ 371 Date: Jun. 14, 2023

(30) Foreign Application Priority Data
Dec. 15, 2020 (GB) 2019771.1

(51) Int. Cl. H02J 15/00; H02J 3/38; H02J 3/28; C25B 15/023; C25B 9/77; C25B 9/65

(52) U.S. Cl. CPC H02J 15/008; H02J 3/381; H02J 3/28; C25B 15/023; C25B 9/77; C25B 9/65

(57) ABSTRACT

A control system for a micro-grid comprising a plurality of electrolysers and one or more primary power sources, the control system being configured, under control of a processor, to: determine power available from the one or more primary power sources; and generate control signals configured to cause available power to be directed to one or more of said plurality of electrolysers; wherein, the control system is configured to be communicably connectable to in-situ diagnostic means associated with each of the electrolysers of said plurality of electrolysers for measuring a respective performance parameter, the control system being configured, under control of said processor, to receive signals from said in-situ diagnostic means and determine therefrom at least one performance parameter associated with said plurality of electrolysers.

The present invention relates to a control system for a micro-grid comprising a plurality of electrolysers and one or more primary power sources, such as one or more renewable energy sources, and to a method for operating/controlling a bank of electrolytic cells, the electrolytic cells and other components forming a micro-grid.

Hydrogen is poised to be a key factor in the energy transition, as well as already being used as industrial feedstock in a variety of industries ranging from fertiliser production to oil refining. Hydrogen is an abundant element, but not often found alone. As such Hydrogen is widely obtained by steam reformation for its industrial applications. This requires the use of fossil fuels and is energy intensive. Undesirable emissions are a by-product of steam reformation. In addition to its uses as an industrial feedstock, hydrogen is an excellent energy vector, allowing for long term storage and transportation.

Electrolysis, as a means for splitting hydrogen and oxygen in water, is well known. A more recent development is electrolysis using an anion exchange membrane (AEM). Unlike other types of electrolysis, this has the benefit of not requiring fossil fuels, as well as not being reliant on platinum group metals (PGM) as a catalyst. AEM electrolysers are more suitable for intermittent operation, unlike other more traditional forms of electrolysis. This lends itself to the possibility of utilising renewable sources of power, such as, but not limited to, solar, wind, hydroelectric, etc.—a commonality being the intermittent nature of these power sources.

In some instances, hydrogen may be desired for near instant use, e.g. in heating applications. It is desirable to be able to control the plurality of hydrogen generators to prevent too much being generated and overloading the boiler.

There have been incentives in numerous countries to stimulate the uptake of renewable energy, such as photovoltaic panels. The intermittent nature of such power sources necessitates a means for energy storage. Batteries can be, and are, used but are not suited to long term storage, due to the fact that batteries are known to discharge over time. Hydrogen is more suited to long term energy storage, because, once stored, the discharge or loss of potential energy seen in batteries simply does not occur. Pairing renewable energy with electrolysers to produce green hydrogen is a means to allow for the energy transition and decarbonisation.

The electrolytic production of hydrogen by splitting water is well known and established. The most established of these technologies is liquid alkaline (LA). Another relatively established form of electrolyser is one utilising Proton Exchange Membranes (PEM). A relative newcomer is electrolysis using an Anion Exchange Membrane (AEM). A benefit of AEM over other relatively more established technologies is that the required media is not as corrosive/caustic, nor are platinum group metals required as a catalyst. Additionally the stack does not need to be made using expensive materials such as titanium.

It is known to have a plurality of smaller devices forming a bank to function as a single unit, and batteries can be arranged and utilised in such a format. However, some such arrangements have limitations in determining which devices to run, and at what capacity. The means and methods employed with such arrangements vary and are subject to further improvement.

An object of the present invention is to provide an improved means and method for controlling a plurality of modular devices, such as, but not necessarily limited to, a bank of electrolysers.

According to an aspect of the invention, there is provided a control system for a micro-grid comprising a plurality of electrolysers and one or more primary power sources, the control system being configured, under control of a processor, to:
determine power available from the one or more primary power sources; and
generate control signals configured to cause available power to be directed to one or more of said plurality of electrolysers;
wherein the control system is configured to be communicably connectable to in-situ diagnostic means associated with each of the electrolysers of said plurality of electrolysers for measuring a respective performance parameter, the control system being configured, under control of said processor, to receive signals from said in-situ diagnostic means and determine therefrom at least one performance parameter associated with said plurality of electrolysers.

Preferably, the control system is configured to derive any one or more of: polarisation curves; ohmic resistance, and; EIS using data received from said in-situ diagnostic means.

Preferably, the polarisation curves are generated at predetermined intervals.

Preferably, each electrolyser is allocated unique identifier data.

Preferably, the control system is configured to obtain or determine any one or more of the following performance parameters from the in-situ diagnostic means in respect of each of one or more said plurality of electrolysers:
cumulative run time of each modular device,
cumulative down time of each modular device,
capacity at which the modular device has been run at whilst running,
Temperature of the device,
Pressure of the device,
Voltage/potential of the device, and
Data pertaining to the balance of plant such as
   Electrolyte flow
   electrolyte level
   conductivity of said electrolyte
   pump performance.

Preferably, any one or more of the performance parameters is measured at predetermined intervals and/or upon a pre-determined trigger.

Preferably, the trigger includes one or both of a change of power supply and a forecast change of conditions.

Preferably, each electrolyser has a Weighted Run Time (WRT) associated to it.

Preferably, the control system is further configured, under control of the processor, to perform power balancing in respect of said plurality of electrolysers.

Preferably, the control system is configured to receive output signals from each of said plurality of electrolysers, and being configured, under control of the processor, to predict an output of each electrolyser and to compute a predicted output based on an allocated distribution of power to said plurality of electrolysers.

According to another aspect of the invention, there is provided a microgrid comprising a plurality of electrolysers, one or more primary sources of power, in-situ diagnostic means associated with each of the electrolysers for measuring respective performance parameter, and a control system as aforementioned, the control system being communicably connectable to the in-situ diagnostic means.

Preferably, at least one of the primary power sources is a renewable energy source or a grid connection.

Preferably, the microgrid additionally comprises one or more secondary power sources.

Preferably, at least one of the secondary power sources is a renewable energy source or a grid connection.

Preferably, each electrolyser is an AEM electrolyser operating with a dry cathode.

Preferably, the microgrid further comprises one or more alternative loads.

Preferably, the alternative load is any one or more of:
one or more batteries;
electrochemical energy storage devices;
capacitors;
appliances, or grid.

Preferably, the microgrid further comprises means, communicably coupled to the control system, for measuring the power available from the one or more primary power sources.

Preferably, the one or more primary power sources comprise renewable energy sources, the microgrid further comprising forecasting means, communicably coupled to the control system, for forecasting the power expected to be available from the one or more primary power sources.

Preferably, the forecasting means comprises any one or more of:
Weather forecasting;
Windspeed forecasting;
Cloud cover; and
Tidal states.

Preferably, the electrolysers are adapted to run at different capacities.

Preferably, the electrolysers have passive charge/discharge circuitry for use by the in-situ diagnostic means for measuring respective voltage transience and include means for using said transience for fitting pre-determined equivalent circuit parameters.

Preferably, the power from the one or more primary power sources is AC or DC, and the one or more electrolysers are powered by either AC or DC.

Preferably, the microgrid includes means for the handling and use of hydrogen output from said electrolysers, such as a dryer, hydrogen storage means or a fuel cell.

According to another aspect of the present invention, there is provided a method for operating/controlling a bank of electrolytic cells, the electrolytic cells and other components forming a micro-grid, the method comprising the following steps:
allocating a unique identifier to each of the one or more electrolytic cells, said electrolytic cells being the primary load for the microgrid; and, at intervals repeating the steps of:
determining/estimating power output from one or more sources of power;
determining which and how many of the electrolytic cells are available for operation;
determining a set point for the or each available electrolytic cell;
directing said power to one or more electrolytic cells, and monitoring the activity of each of the electrolytic cells;
measuring in-situ diagnostic data and logging the results in association with unique identifier data for each electrolytic cell;
measuring actual power output and comparing it to expected power output; and
repeating the above steps at regular pre-determined intervals, and reducing a set point of one or more of said electrolytic cells in the event that power output is insufficient or operation of one or more of the electrolytic cells is not required.

As used herein primary power is used to denote the power source in the first instance. This may include, but is not limited to, one or more of solar power, wind, hydro and other renewable sources, as well as optionally including or comprising power from more traditional sources, such as a larger scale grid. Two or more power sources may be considered primary power sources i.e. solar panels and a wind turbine.

As used herein, the term micro-grid is used in reference to a system in accordance with an aspect of the present invention comprising, but not limited to, a plurality of electrolysers, each of the electrolysers of said plurality of electrolysers having associated therewith in-situ diagnostic means for measuring a performance parameter thereof, and a control system substantially as described above.

As used herein, the term electrolyser may be used interchangeably with the term modular device and/or cell or electrolytic cell, including electrochemical cells of all forms. One or more electrolysers and (optionally) other modular devices may be termed the primary load(s), or simply load(s). Additionally reference includes strings of modular devices, normally electrochemical stacks, a string being multiple stacks sharing means for in-situ diagnostics.

As used herein, the terms computer, processor, computing means or processing means are intended to include, but not necessarily limited to, any device with data processing or computing capabilities, such as, but not limited to, a PC (personal computer), laptop computer, smartphone, tablet computing device, etc. As the control system is also a form of computing means, the terms may be used herein synonymously without limitation.

As used herein, the term user may be used to refer to any person associated with the system, such as, but not necessarily limited to, a manager, systems integrator, supervisor, owner. A user may be any individual with an interest in the control of the system or, indeed, a group of interested parties or a company or organisation.

As used herein, a bank of devices is used to refer to a plurality of modular electrolysers.

As used herein, the term connection can refer to either a physical (wired) or wireless data connection, such as, but not limited to, wired data transmission connection, Bluetooth® or WiFi. Any means for communication of data or information from one component to another may constitute a connection.

As used herein, the term communicable connection is used to refer to a data connection system or network capable of transmitting information such as IoT, WiFi, Bluetooth® or physical wired connections. Means such as a gateway are disclosed herein to facilitate the communication between devices operating with different protocols. Alternatives include a PLC (programmable logic controller).

As used herein, in-situ diagnostic means may refer to any equipment means or method of assessing the health or status of an electrolyser, and more generally the or each primary load. Such in-situ diagnostic means and associated diagnostic equipment is discussed in more detail hereinafter.

Whilst primary power sources and ‘loads’ have been discussed, it is noted that secondary power sources may be used to supplement the primary sources should the output product, normally hydrogen, be required in a case where there is insufficient power for requisite generation from the primary sources alone. A secondary power source may be another grid, a generator, or other system capable of providing power. Secondary loads may include appliances, or any device requiring power. Batteries may form both a secondary power source and a secondary load, however, in this case, the control system may be configured to ensure the batteries do not fall below a predetermined threshold.

It should be noted that not all of the balance of plant (BOP) is discussed in depth in this application as such associated issues will be readily apparent to an individual of ordinary skill.

In a preferred embodiment, the one or more sources of power are renewable sources, such as, but not limited to, solar power, wind power, hydro, etc. The present invention lends itself particularly, although by no means exclusively, to use with sources of power which may be intermittent, inconsistent and/or changeable, which are common characteristics of renewable energy sources in particular.

In addition to the one or more sources of primary power, it is envisaged that an alternative power source may be used. The alternative power source may be a connection to another grid, on a national or more local “micro-grid” scale. Indeed, one or more batteries or other means for energy storage may be employed as the alternative power source. It is also envisaged that a battery or bank of batteries may be used as an alternative load. An alternative load, especially one capable of also being an alternative power source, includes but is not necessarily limited to electrochemical energy storage devices such as batteries using Li systems, Na/Zn/Al systems, or redox flow—alternatively, capacitors, such as, but not limited to, supercapacitors or ultracapacitors may be used.

In a preferred embodiment, the electrolysers (or ‘loads’) forming the plurality of electrolysers may be AEM electrolysers. More preferably still, at least some of them may comprise AEM electrolysers adapted to operate with a substantially dry cathodic compartment. However, the present invention is not intended to be limited to just a plurality of electrolysers being the complete load. Indeed, if the micro-grid is integrated into a larger grid, other energy demanding devices may constitute other loads, such as but not limited to, household or commercial appliances, lighting, industrial machinery and more. As discussed above, a load may also act as an alternative power source.

It is envisaged that the one or more primary power sources may, at some points in time, provide more power than can be used by the bank of electrolysers. Instead of curtailing, and thereby wasting, such power it is preferred to supply one or more alternative loads for the supplied power, such as, but not necessarily limited to one or more batteries, electrical grid, household, or other power requiring device/system. Preferably, the control system is configured, under control of the processor, to control the demand side response and the utilisation of alternative loads or the batteries.

In a preferred embodiment, one or more means are provided to measure and/or monitor the power available from the one or more power sources, one or both of primary and secondary power sources. Additionally, connections may be provided to the alternative power source(s) and alternative load(s) for the control means, and as a means for transmitting power. Preferably, the control system is configured to generate signals configured to route the power to the correct load or loads, based on the measured power availability.

In the instance of renewable energy, the control system may be configured to forecast available power from the one or more sources by utilising weather forecast data. Utilising such additional information helps to further reduce reaction time of the micro-grid system. A further adaptation is envisaged wherein means are provided to forecast available power from the one or more power sources. Ramping of the one or more loads may be done via the alternative power supply to increase the reaction speed of the bank of devices. Examples include wind speed forecasting, or cloud cover combined with sunrise and sunset. It is also envisaged that means for recording forecast conditions and available power from the relevant supply, eg. wind speed and power from wind turbines, Cloud cover and solar panel output, tidal state and hydropower etc. In such embodiments, it is envisaged that means for comparing forecast conditions to available power for more accurate operation of the bank of devices, and alternative loads and power source.

In a micro-grid system according to an aspect of the present invention, a plurality of different devices may be utilised. As such the control system may be used to control the micro-grid according to data received from a plurality of different sources. Whilst a programmable logic controller (PLC) may be used, it is preferred to use a Gateway to allow for devices using different protocols to communicate therewith.

Within a bank or plurality of electrolysers, it is possible to operate the electrolysers at a fraction of peak capacity. For example, instead of one electrolyser being on full, two can be half powered, three one third powered etc. For devices such as electrolysers, this type of operation can reduce the rate of degradation, thereby improving the longevity of the constituent devices of the bank.

Thus, the electrolysers in the plurality of electrolysers may not be restricted to operating at the same capacity. For a variety of reasons, it may be preferable to have some of the electrolysers operating at a variety of capacities. Such reasons may include peak efficiency being achieved at different capacities, or allowing some devices to be crutched until maintenance can be provided. If needed, the control system is preferably configured, under control of the processor, to facilitate this, and monitor the performance of the micro-grid to determine if this can be achieved whilst still meeting a predetermined threshold of output. If the desired (predetermined) output may not be reached at peak efficiency, an alert may be presented to the user.

Examples of in-situ diagnostic means that may be used in a micro-grid system according to an aspect of the invention are described in more detail below.

Electrolysers, notably PEM and AEM electrolysers, generally comprise a stack, each stack having a plurality of cells. It is possible to determine the health of a cell, group of cells or an entire stack by generating a polarisation curve. Whilst this may be done on an ad-hoc basis, the micro-grid system is beneficially adapted to perform diagnostics at predetermined intervals, and/or at certain milestones. The present invention is not intended to be limited to the use of polarisation curves as a means for in-situ diagnostics. Alternative methods include measuring potential of each cell or cells at a set current. Additionally, means may be provided for the comparison of actual output vs. predicted output based on the power supply. If multiple in-situ diagnostic means are utilised, each in-situ diagnostic means could be used alone or in combination.

In the above-referenced exemplary embodiment of generating polarisation curves, the appropriate means shall be included. An electrolytic stack comprises a plurality of cells, each cell being bordered by a bipolar plate. An envisaged order of the cell stack is: bipolar plate, anode, membrane, cathode, bipolar plate and repeated for the total number of cells within the stack. A gas diffusion layer (GDL) may be placed between the bipolar plate and the catalyst layer alone or incorporating a microporous layer (MPL). For reasons including pressure tolerance and other mechanical considerations, endplates may be provided. These may act as bipolar plates or be insulated from said bipolar plates and as such be distinct components. It is envisaged that the polarisation curve generated by the control system may be derived using data for a single cell, or group of cells, examples of this are depicted in the figures associated with the detailed description below. The bipolar plates or equivalent are generally provided with pins or other conductive or otherwise suitable connection means to allow for the measurement of requisite data. The pins may be connected to computing means, or another suitable device such as a stack board. In embodiments utilising a stack board, it is envisaged that this will be a PCB, regardless, the stack board will be communicably connected to the control system.

Additionally, it is envisaged means are provided for the logging and optional transmission for the in-situ diagnostics and other performance related measurements.

It is envisaged that each electrolyser in the plurality or bank of said electrolysers is allocated with an identifier/code to allow the targeted control and allocated power distribution to each modular device. This should need to be done only when setting up a system, or if a device is added/replaced.

As discussed above, means for in-situ diagnostics are provided. Such means may record any one or more of the following:
cumulative run time of an electrolytic cell or group of electrolytic cells;
cumulative down time of an electrolytic cell or group of electrolytic cells;
capacity at which an electrolytic cell or group of electrolytic cells has been run at whilst running;
Temperature of an electrolytic cell or group of cells,
Pressure of an electrolytic cell or cells,
Voltage/potential of an electrolytic cell or cells;
Time to discharge;
Voltage transience during discharge; and
Data pertaining to the balance of plant such as
   Electrolyte flow
   electrolyte level
   conductivity of said electrolyte
   pump performance.

The above list is not necessarily exhaustive, any reasonable performance or operating condition from which the status of a component may be determined or inferred may be used, in addition or alternatively.

It is envisaged that, based on the previously monitored operating conditions and outputs, including but not necessarily limited to start up and shut down transience; means are provided to predict outputs extrapolated from the previous operating conditions.

Where appropriate, such measurements may be taken at pre-determined intervals by the in-situ diagnostic means, which may optionally be amended by the user. Additionally, triggers may be given for the instigation of diagnostics. Such triggers could be a change of power supply, forecast change of conditions or any other conceivable trigger.

It is envisaged that the above information may be used by a control system according to an aspect of the invention to determine a “weighted run time” (WRT) for each electrolytic cell in a bank, the WRT taking into account factors such as, but not limited to run time, power supplied whilst running, and down time.

There are a variety of ways in which the WRT may be used to control the operation of the micro-grid as a whole. Priority may be given to the cell with the lowest WRT, however it may be preferable to prioritise another device depending on the State of Health, discussed below, should the in-situ diagnostics show or indicate an issue with a device having a lower WRT than other devices. This may be supplemented by the polarisation curve or other diagnostic techniques. A device may have reduced priority even with a lower WRT if in need of maintenance, or a potential issue has been detected.

In another embodiment, extra weighting may also be given to the time elapsed since the electrolyser or electrolytic cell was last in operation. Certain electrolytic cells may degrade if not operated frequently, or not purged between operations, or stored improperly. For example, electrolysers may run the risk of a membrane drying, corrosion or embrittlement if left for too long without running.

Preferably the electrolyser with the lowest WRT, based on any one or more of the above factors will be given preference to be the first modular device to receive power. As discussed above wherein multiple modular devices may be partially powered, it is envisaged that the system control means is adapted to direct power, and be able to alter the power supplied to the or each modular device based on the WRT and/or other in-situ diagnostics discussed above.

It is envisaged that the power from the one or more power sources can be either AC, or DC. It is also envisaged that the bank of modular devices will operate with AC, or DC. Accordingly, if power is not generated in the required form, any of the following devices may be used: Inverter, rectifier, transformer or other requisite component to ensure compatibility between the loads and power sources and intermediary components. Indeed, such components may be required in more than one location. Such devices may have optional connections to the control system.

It is envisaged that a user, the user being a person, such as but not necessarily the manager of the system, may wish to monitor the performance of the system being managed remotely. A computer can be used to access a dashboard, or app, either displaying performance related data. In some embodiments, it is envisaged that forecast performance data may also be included.

In the preferred embodiment, wherein the modular devices are electrolysers, it is envisaged that the system will further comprise any of the following: means for storing hydrogen, means for drying hydrogen, hydrogen refuelling stations, a fuel cell or other device/process requiring hydrogen.

Power balancing means, preferably fast acting power balancing means are provided. In the event an excess of power is supplied a power sink may be provided to protect the components.

Means for measuring output of each electrolyser and computing means for predicting said output based on a supply of power may also be used to control the system and loads within said system. For example, if an electrolyser is producing less than the expected amount of hydrogen for a given power supply, this implies an issue with that stack. An additional control device such as PID controller may be employed.

The optional features disclosed for the system embodiments described above may be included and controlled by the method of operating such a microgrid substantially as described above.

The available power from the primary source can be calculated as follows:

Power available=output from primary source×efficiency of transmission

It should be noted that the efficiency of transmission also accounts for the efficiency of inversion, should it be required such as DC/AC, or vice versa.

In order to better control the distribution of power to a plurality of electrolytic cells, it is envisaged that forecasting of power output from the one or more power sources may be performed. Where renewable sources are used, this could involve analysis of weather forecasts, with machine learning employed to correlate such forecasts to actual available power. Additionally, in an embodiment wherein PV panels are used, should output drop during daylight hours it may be possible to attribute this to passing clouds. Optical sensors, or even user input may be used to inform the system. In such instances a temporary reduction as opposed to transitioning to standby mode may be preferred.

It is envisaged that alternative power sources may be employed to allow for the operation of the bank of primary loads i.e. the electrolysers to allow for continued production of hydrogen, or equivalent output.

It is envisaged that the alternative load may be a battery bank, which can also be used as a buffer to ensure a smooth, relatively consistent power supply. Alternatively appliances or devices in the microgrid may be alternative loads such as air conditioning, refrigeration, lights and more. Yet another alternative load could be a connection to a larger grid, or other micro-grid to allow for the maximisation of use of product.

By regularly measuring the available power it will occur that the power available is not sufficient to power the same number of electrolysers at the same capacity. The WRT or equivalent can then be used to reallocate power and ramp up or down loads as appropriate. If a forecast indicates that the change is short term then secondary loads or power sinks may be utilised. Such an approach helps to minimize cycling on and off of devices, which helps to increase their longevity.

Other methods of determining a stack's State of Health (SoH), a supplement or alternative to the WRT, generally include fitting the stack to an equivalent circuit model. In the simplest cases said model including resistor and capacitor components, but generally also adapted to include mass transport contributions as well. An example being Randles circuit, which includes a Warburg element to represent mass transport effects. Additionally, constant phase elements, a more general kind of capacitor element, to reflect porous electrodes may be included.

Equivalent circuit fitting of impedance spectra is possible for electrochemical stacks, but to obtain more useful data it is envisaged that fitting such a stack to equivalent circuits either requires electrochemical impedance spectroscopy (EIS) or another circuit through which the stack can passively charge/discharge. Additionally or alternatively means are provided for a distinct discharge circuit to allow for a quantitative analysis—said dedicated discharge circuit allowing for quantitative analysis of SoH. The power supply case allows for a SoH assessment on a relative, qualitative basis. The passive charge/discharge circuitry having requisite switches and resistors to allow passive charging and discharging of the stack. Upon charging and discharging, the resulting voltage transience can be used, with a sufficient sampling rate, wherein said sampling rate is pre-determined, to fit the stack to an equivalent circuit. For the avoidance of doubt, the measured voltage transience may be combined with means for using said transience for fitting pre-determined equivalent circuit parameters. Characteristics of the stack voltage transience can be directly correlated with performance parameters that need to be identified (i.e. ohmic resistance, kinetic activity characteristics, and even mass transport/low frequency behaviour). This arguably increases the hardware complexity but allows for specific determination of parameters associated with individual cell components. EIS generally requires potentiostats which are expensive, however, one such potentiostat may be used to a plurality of electrolysers or strings of electrolysers. A DC bias is applied to the stack with an AC component (+/−1% of the DC bias) such that the frequency of the AC perturbation is swept from kHz to mHz—the impedance is measured at each frequency and this data can be used to fit the stack to an equivalent circuit model. If using a potentitostat, it would be connected to the electrochemical cell, stack or string by known means not described herein.

The ideal case, simplifying the hardware requirements while still obtaining useful information, involves simply looking at the changes in polarization curve data where the below equation separates the three dominating sources of losses: kinetic, ohmic, and mass transport.

$$V = {\underbrace{E}}_{OCV} - {\underbrace{b log ( \frac{i}{{i}_{0}} )}}_{Kinetic} - {\underbrace{i {R}^{′}}}_{Ohmic} + {\underbrace{a log ( 1 - \frac{i}{{i}_{lim}} )}}_{Transport}$$

Yet another diagnostic method includes measuring ΔV, or the change of polarization curve diagnostic. The polarization curve, or voltage versus applied current graph, gives us information of the different kinds of efficiency losses in an electrolyser cell/stack—kinetic, ohmic, and mass transport. Nominally, electrolysers are dominated by kinetic and ohmic losses, the former being a logarithmic V vs I relationship, and the latter being linear between V and I. Though mass transport losses are present in the worst cases, generally it can be taken as the difference between the raw polarization curve data and the kinetic+ohmic fitting data. The kinetic part having two fitting coefficients, these being Tafel slope and exchange current density, which are dependent on the electrochemical reactions of the cell and reflect the state of health of each electrode's catalyst layer. The ohmic part only has one fitting coefficient, this being DC resistance, factors impacting this including membrane state of health and increasing contact resistance due to corrosion. Lastly, mass transport generally has two fitting coefficients, a logarithm prefactor, and the limiting current density, both of which give us an idea of the degree of “resistance” of water getting to the catalyst layer and/or gases leaving the electrodes—mass transport losses mainly arise from the GDL, CL, and/or the membrane.

Consider that nonlinear curve fitting with five free parameters is practically rather difficult in our case and there are time constraints if done too regularly, although improved processing power may go some way to mitigating this—with an associated cost. Ignoring mass transport fitting now and focusing on the kinetic and ohmic allows for simplification. For the fitting procedure and improving accuracy and stability, the ohmic part may be measured and fixed such that the nonlinear curve fitting is only correcting for the two kinetic parameters in the first and only log term. In embodiments wherein one of the fitting parameters is stable, say the Tafel slope, this may be set at a fixed point in the control software/methodology reducing the variable. However, it is preferred to fix something that can be measured quickly such as the DC resistance or other suitable parameter. Deviation from the fitted polarization curve of purely ohmic+kinetic contributions with respect to the measured values can be attributed to mass transport limitation onset, which can also be used to properly define a maximum capacity value.

Some methods for measuring the ohmic part mentioned above include EIS or current interrupt which require a potentiostat or an impedance meter to read the impedance at a fixed high frequency (e.g. 1 kHz). As before a single potentiostat may be centralized and used for multiple stacks. It should be noted that distinguishing between a logarithm and a linear part of a curve is not easily done if there is not enough data, this is normally more pronounced especially at a very low current density which require a long time to remove the capacitive contribution. It is envisaged that the means may be adapted to conduct more measurements at lower current densities to ensure adequate data, lower current densities being half or less than maximum operating capacity. Measuring the resistance by direct methods (e.g. EIS, current interrupt, impedance meter) removes this numerical issue allowing for a fast recording of the polarization curve, requiring less points for an accurate numerical fitting regardless of linear or logarithmic tendencies.

In a preferred embodiment of the present invention means are provided to create a polarization curve at pre-determined intervals such as every 1-1000 hours, 10-100 hours, 100-500 hours, or anywhere suitable within that range. Repeated creation of polarisation curves allows for time rates of change to be determined for each of the fitted voltage loss parameters for a given electrolyser module. With this knowledge, modules can be loaded with a corresponding weight factor in order to increase the lifetime of the aggregate system, in conjunction with catching individual module issues before catastrophic failure, as voltage gains in some cases start with reversible losses that eventually become irreversible. This data may be incorporated with the/a WRT to attribute a SoH.

For embodiments wherein the electrolytic cells are used to generate a product which is consumed, it is envisaged that the control means may be adapted to direct the requisite power to one or more of the cells at a rate to produce only what is to be consumed. This may be predetermined, input by a user or set by another mechanism. Alternatively, when the storage for the product is full, control means may facilitate the supply of power to generate no more than can be safely stored.

It is envisaged that demand side response (DSR) may be used in the event of unexpected power fluctuations. Such instances may result from damage to components, unexpected changes in weather conditions, or changing requirements of operating the electrolytic cells. Alternatives include utilising a power sink or other curtailing means.

There is an optional additional step of the above-described method wherein the collected data is made viewable to a user via a computing means connected to an app, web based or otherwise.

If demand for generated product surpasses that possible from the primary power, the control system may be configured to cause power from the alternative power source or battery bank to be directed as required, so as to supplement the primary power source. If there is no means to store the product, the available power can be routed to alternative loads including the battery bank, depending upon demand. Alternatively, if the battery or bank thereof is low then power may be redirected to it. It is envisaged that a predetermined threshold may be implemented to ensure that the batteries do not drop below a certain percentage charge (to increase their longevity) or a set amount of power as defined by the user or designer of the system.

This section outlines a specific example embodiment of a system in accordance with the present invention.

### Example Calculation of WRT Hours

Generally a basic WRT can be calculated using the basic formula of:

WRT=Percentage power×hours at said power

As an electrolyser may run with varied inputs, the calculation may have to be repeated for each steady state. Yet another option is to integrate to account for operation during ramp up and down of the electrolyser.

EL₁Running at 100% for 100 hours−WRT=100 hours

EL₂ Running at 50% for 100 hours−WRT=50 hours

EL₃ Running at 30% for 200 hours−WRT=60 hours

Using WRT alone, in the above example Priority may be given to EL₂, having the lowest WRT despite having been operated half as many hours as EL₃ and for the same number of hours as EL₁. As an electrolyser may run at various load capacities for differing hours, the sum of these may be calculated.

The WRT may be further supplemented by the forecast means, and optionally a temperature sensor. Electrolysers need time to ramp up to be operational. It is not desirable for power to be wasted during this ramp up process, utilisation of temperature sensors allows for more accurate control by either providing heating where required and prioritising devices closer to the pre-determined operable range.

Whilst each electrolyser may be a standalone unit, in one embodiment it is envisaged that the electrolyser stacks will form one part of a multicore system. A multicore or multicluster having a plurality of electrolyser stacks wherein there is a shared BOP.

To help understanding of the invention, a specific embodiment thereof will now be described by way of example only and with reference to the accompanying drawings, in which:

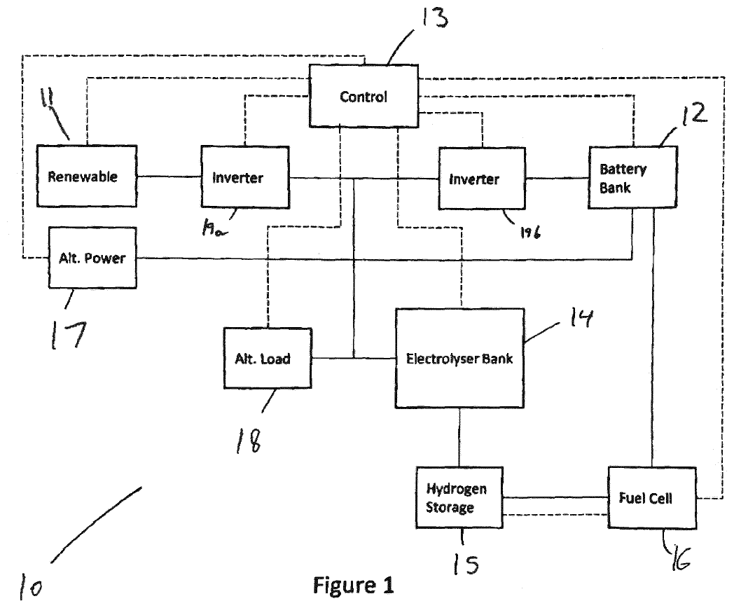

FIG. 1 is a schematic illustration of an example Microgrid;

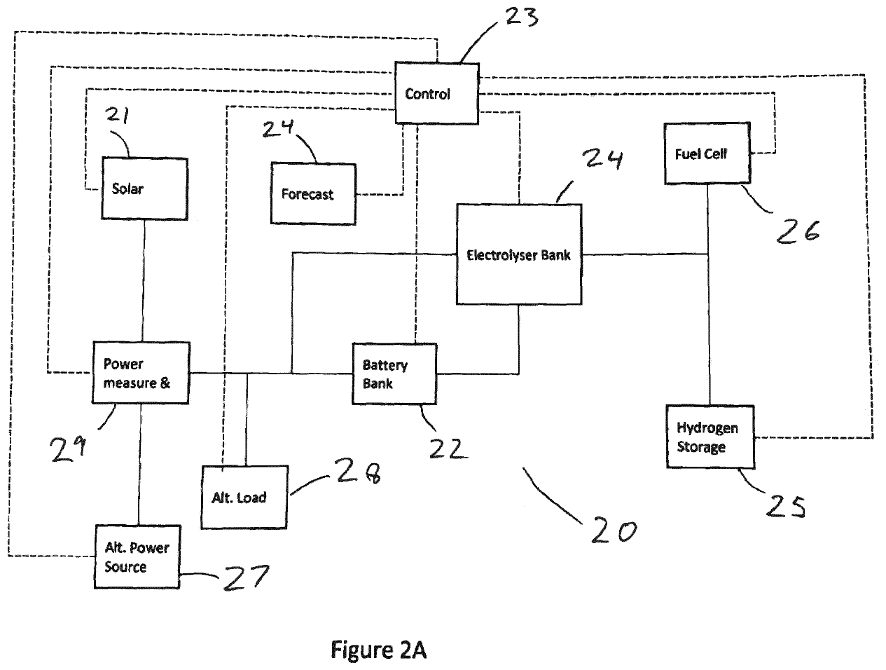

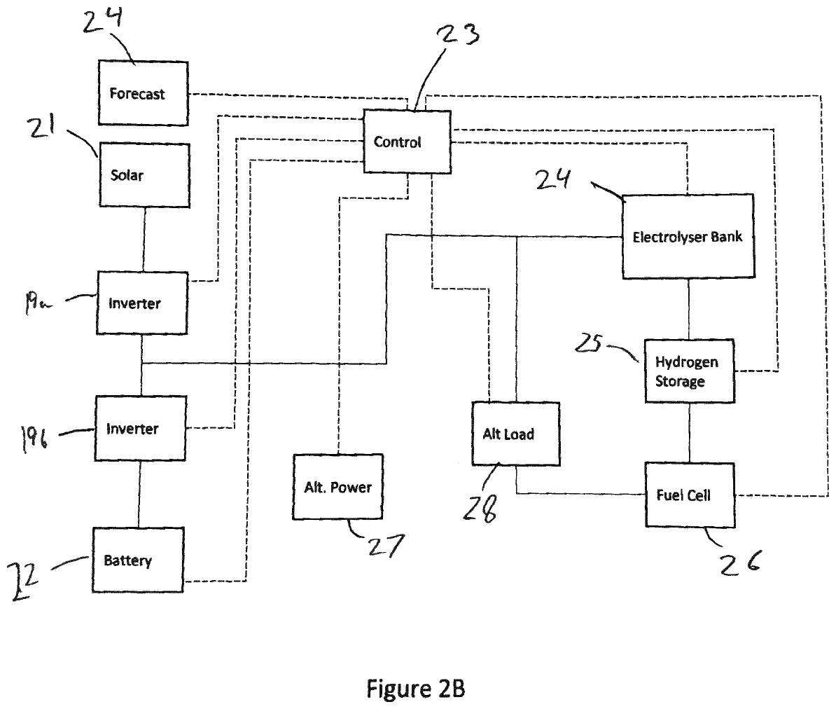

FIGS. 2A and B illustrate schematically examples of alternative microgrids;

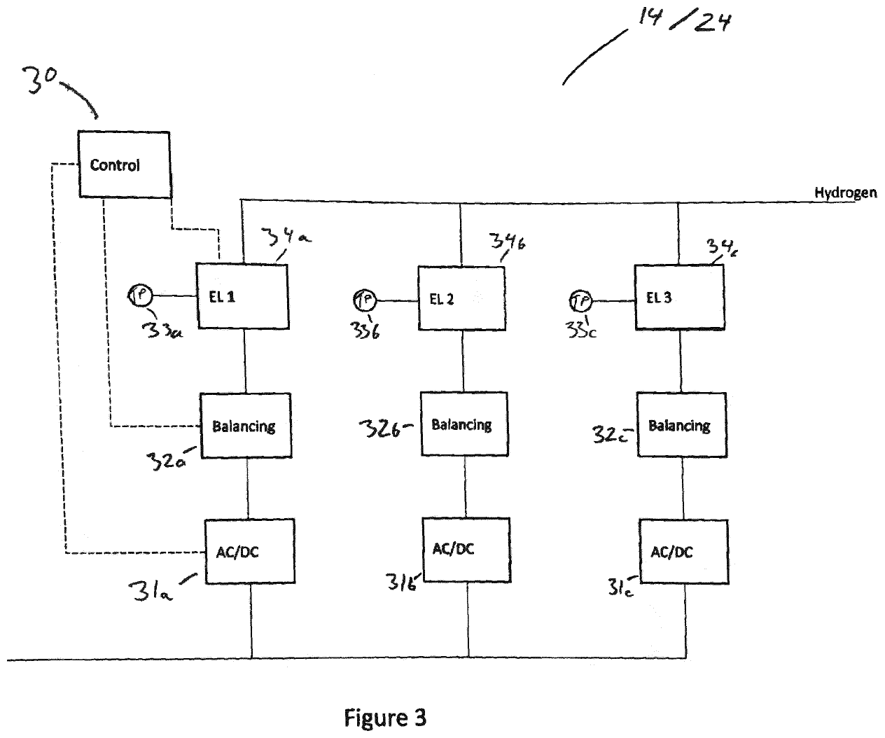

FIG. 3 is a schematic illustration of an electrolyser bank;

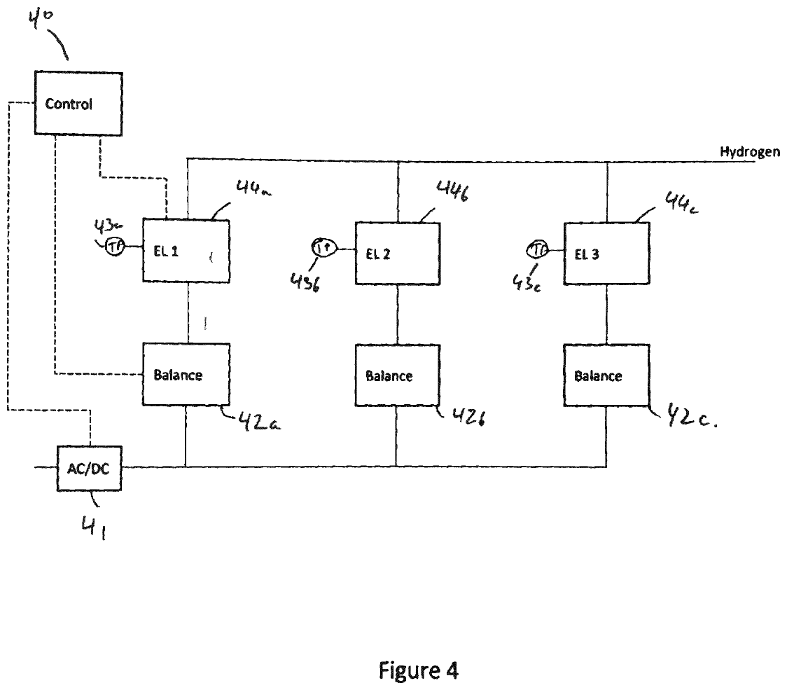

FIG. 4 illustrates schematically an example of electrolyser bank depicted in FIGS. 1 and 2;

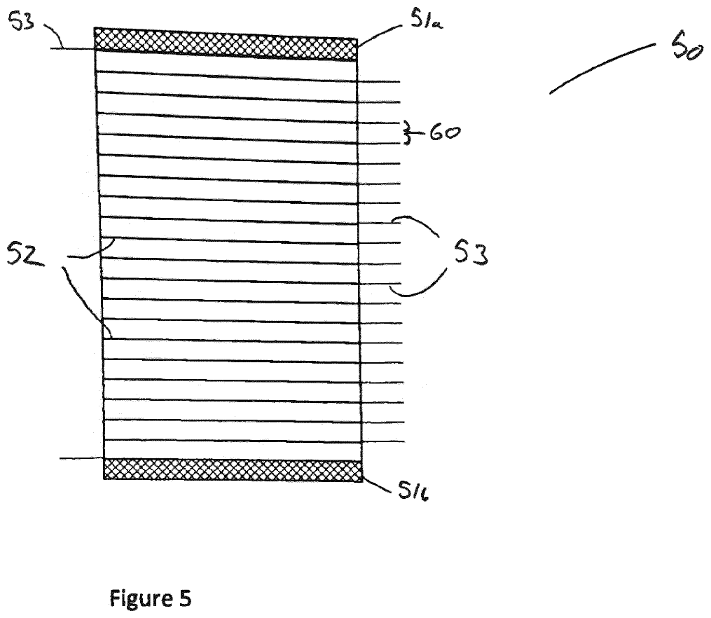

FIG. 5 is a schematic illustration of an example electrolytic stack;

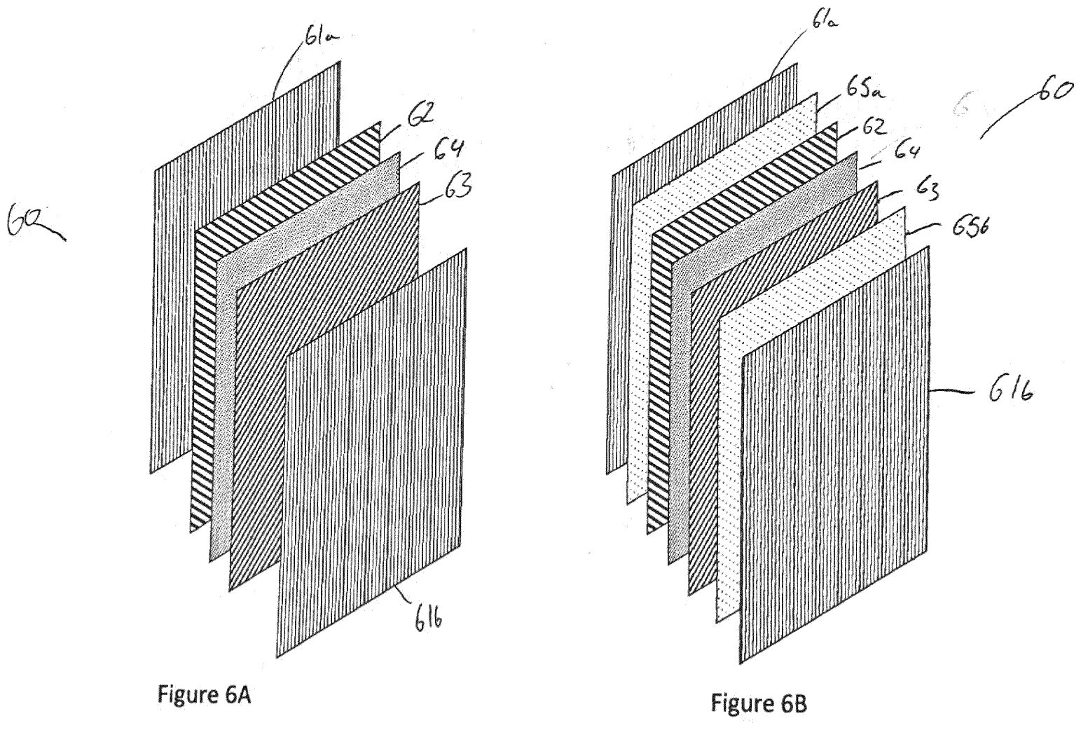

FIGS. 6A and B illustrates schematically an example of a cell arrangement found in the stack depicted in FIG. 5;

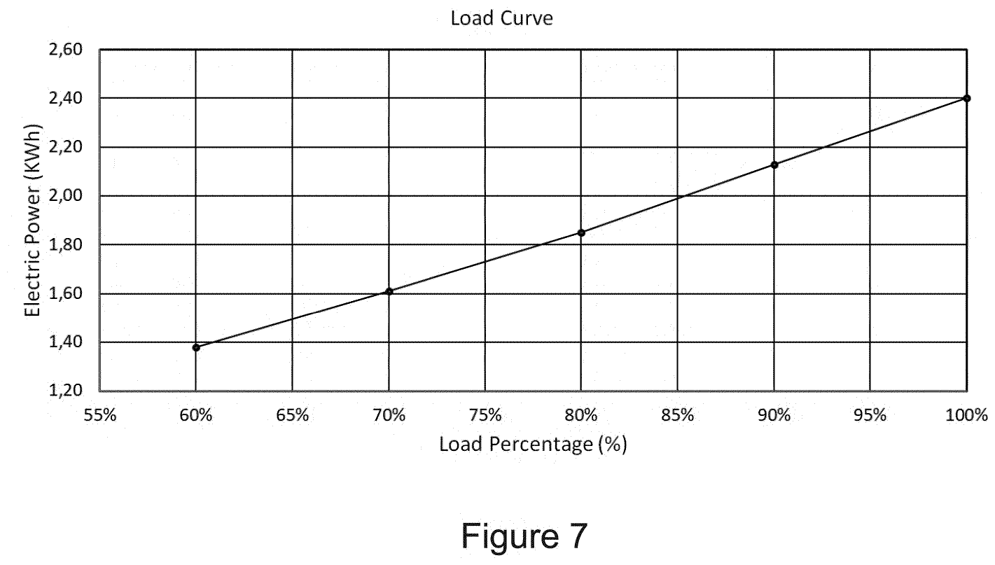

FIG. 7 Illustrates graphically a load curve of Electrolysers; and

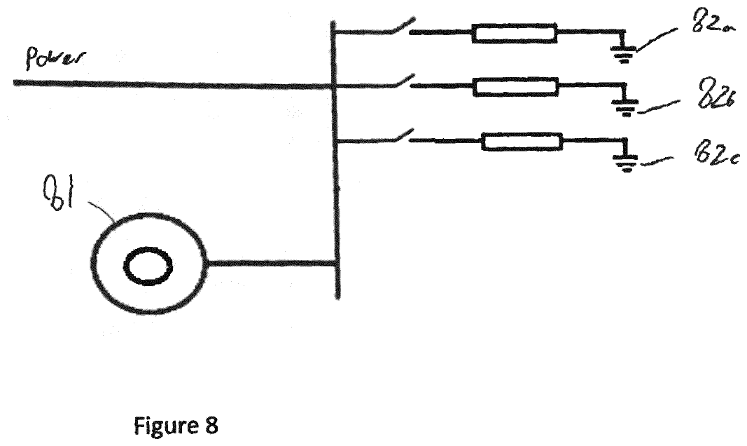

FIG. 8 is a schematic diagram showing an example arrangement for the distribution of power from the one or more power sources to the primary or alternative loads.

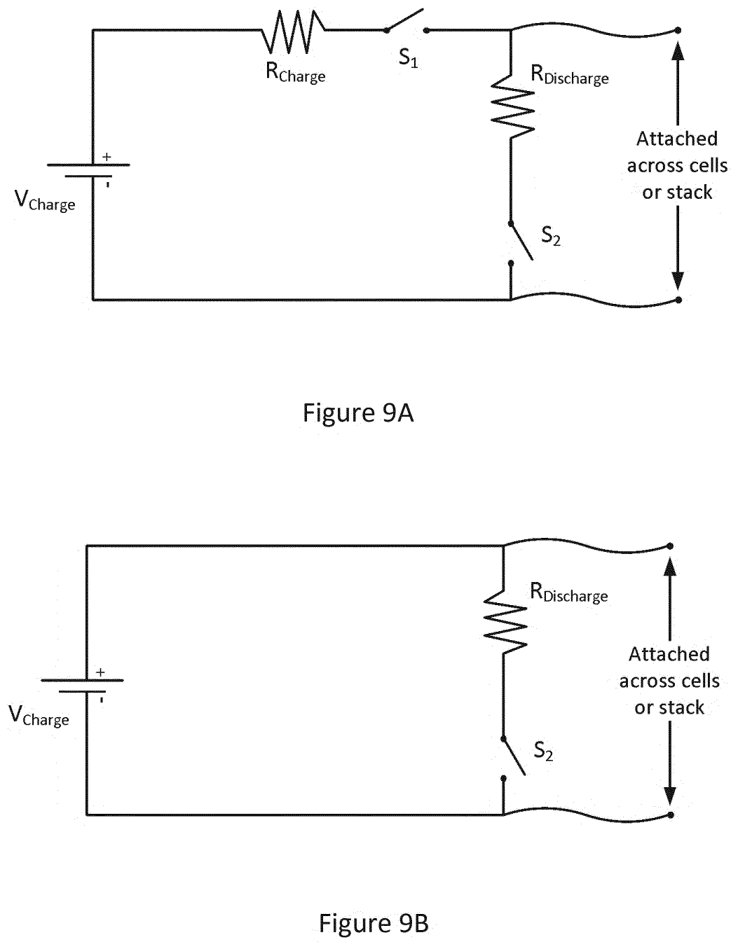

FIGS. 9A and 9B depict diagnostic circuits.

Referring to FIG. 1, an example microgrid is illustrated schematically. The solid lines denote either means for the transmission of power, either AC or DC, or the transportation of Hydrogen. In use, Hydrogen will be transported from relevant devices such as the Electrolysers 14 to hydrogen storage 15 and onwards to the fuel cell 16. Not all connections are shown. The dashed lines show the data communication connection, which may be wired or wireless, from devices such as the inverter 19a, 19b or electrolyser 14 to the control/gateway 13.

In the example grid illustrated schematically in FIG. 1, the renewable energy source 11 feeds to an inverter 19a. From the inverter the generated power may either charge a battery 12 via an inverter 19b, or be directed to the electrolyser bank 14 for the powering of the one or more primary loads. The control 13 dictates which of the electrolysers in said bank 14 are powered and at what capacity. Generated hydrogen may go directly to a fuel cell 16 or be stored in a hydrogen storage tank 15. Means for drying produced hydrogen are not shown, for the sake of clarity.

In the event that hydrogen is required, or the battery charge is low, power may be used from an alternative power source 17, such as a larger regional or national grid. The alternative power source 17 may also be connected such that it could power the fuel cell 16 or alternative load 18 if needed. The presence of an alternate load 18 is preferable to a power sink (not shown), which could be used but would result in a true waste of energy, which is clearly undesirable.

The Electrolyser bank 14 is beneficially adapted to utilise in-situ diagnostics as described herein and depicted in later figures. Such in-situ diagnostics are used to adapt the control philosophy of the micro-grid in real time at predetermined intervals.

FIG. 2A depicts an alternative microgrid structure. In this embodiment, compared with the embodiment depicted in FIG. 1 of the drawings, there are alternative and additional components, as can be seen. In this embodiment, power is generated by either a renewable power source 21 or an alternative power source 27. The power is routed by the power measurement and distribution control block 29. Power may be distributed by this control block 29 to either an alternative load 28 or electrolyser bank 14 via a battery bank 22, which acts as a buffer, and alternative means for storage. As in FIG. 1, hydrogen generated by the electrolyser bank 14 may be routed directly to a fuel cell 26, or stored in storage tanks 25.

The control/gateway 23 is communicably connected to relevant devices, as denoted by the dashed lines. Means for forecasting power generation 24 are provided. For example, an irradiance sensor could be used for this purpose if the renewable power source 21 comprises or includes PV panels.

In FIG. 2B yet another example microgrid structure can be seen. This arrangement may be considered as a combination of the microgrid structures of FIGS. 1 and 2A.

FIGS. 3 and 4 both depict schematically a an example arrangement of an electrolyser bank 14. Connections to in-situ diagnostics are not shown (for the sake of clarity), but connections to sensor 33abc/44abc are shown. Referring to FIG. 3 of the drawings first, power is supplied to the electrolysers 34abc via inverter 31abc if required. Also depicted, but only optionally included, are power balancing means/buffers 32abc to ensure a steady supply of power to the electrolysers. Sensors 33abc are connected to the electrolysers are sensors for the measurement of temperature and/or pressure. Each device (i.e. each electrolyser 34abc, balancing means/buffer 32abc and power supply 31abc) is communicably coupled to the control/gateway 30, as would be the in-situ diagnostics used to allocate energy to each electrolyser. As discussed above each electrolyser may receive a different load. Hydrogen leaves each electrolyser to be directed to storage or a fuel cell or other application.

FIG. 4 differs to FIG. 3 in that it is a leaner, more efficient approach. Power enters via an (optional) inverter 41 before being directed straight to electrolyser 44abc. Sensors 43abc are connected to the electrolysers as in the arrangement of FIG. 3, and the data collected by said sensors communicated to control/gateway 40. Means for balancing, such as a battery, or power sink 42 are provided. Generated hydrogen is handled as described above with respect to FIG. 3.

Referring to FIG. 5 of the drawings, there is illustrated schematically an electrolytic stack 50, as could be used in the electrolyser bank 14 adapted for in-situ diagnostics. As can be seen, the stack is bordered by endplates 51a and 51b. Between said endplates are a plurality of cells 60, the composition of each may be seen in FIGS. 6A and 6B and described in more detail below. Bordering each cell 60 are bipolar plates 52. In order to conduct in-situ diagnostics as described above, the pins 53 are connected to the bipolar plates 52. The pins are connected to a stack board (not shown) to conduct the diagnostics, the results of which are communicated to the control/gateway and used for determining load distribution to each stack 50.

As discussed above, means for in-situ diagnostics are provided. Such means may record any one or more of the following:
cumulative run time of an electrolytic cell or group of electrolytic cells;
cumulative down time of an electrolytic cell or group of electrolytic cells;
capacity at which an electrolytic cell or group of electrolytic cells has been run at whilst running;
Temperature of an electrolytic cell or group of cells,
Pressure of an electrolytic cell or cells,
Voltage/potential of an electrolytic cell or cells; and
Data pertaining to the balance of plant such as
   Electrolyte flow
   electrolyte level
   conductivity of said electrolyte
   pump performance.

The above list is not necessarily exhaustive, any reasonable performance or operating condition from which the status of a component may be determined or inferred may be used, in addition or alternatively.

It is envisaged that, based on the previously monitored operating conditions and outputs, means are provided to predict outputs extrapolated from the previous operating conditions.

Where appropriate, such measurements may be taken at pre-determined intervals by the in-situ diagnostic means, which may optionally be amended by the user. Additionally, triggers may be given for the instigation of diagnostics. Such triggers could be a change of power supply, forecast change of conditions or any other conceivable trigger.

It is envisaged that the above information may be used by a control system according to an aspect of the invention to determine a “weighted run time” (WRT) for each electrolytic cell in a bank, the WRT taking into account factors such as, but not limited to run time, power supplied whilst running, and down time.

There are a variety of ways in which the WRT may be used to control the operation of the micro-grid as a whole. Priority may be given to the cell with the lowest WRT, however it may be preferable to prioritise another device depending on the State of Health, discussed below, should the in-situ diagnostics show or indicate an issue with a device having a lower WRT than other devices. This may be supplemented by the polarisation curve or other diagnostic techniques. A device may have reduced priority even with a lower WRT if in need of maintenance, or a potential issue has been detected.

In another embodiment, extra weighting may also be given to the time elapsed since the electrolyser or electrolytic cell was last in operation. Certain electrolytic cells may degrade if not operated frequently, or not purged between operations, or stored improperly. For example, electrolysers may run the risk of a membrane drying, corrosion or embrittlement if left for too long without running.

Preferably the electrolyser with the lowest WRT, based on any one or more of the above factors will be given preference to be the first modular device to receive power. As discussed above wherein multiple modular devices may be partially powered, it is envisaged that the system control means is adapted to direct power, and be able to alter the power supplied to the or each modular device based on the WRT and/or other in-situ diagnostics discussed above.

It is envisaged that the power from the one or more power sources can be either AC, or DC. It is also envisaged that the bank of modular devices will operate with AC, or DC. Accordingly, if power is not generated in the required form, any of the following devices may be used: Inverter, rectifier, transformer or other requisite component to ensure compatibility between the loads and power sources and intermediary components. Indeed, such components may be required in more than one location. Such devices may have optional connections to the control system.

It is envisaged that a user, the user being a person, such as but not necessarily the manager of the system, may wish to monitor the performance of the system being managed remotely. A computer can be used to access a dashboard, or app, either displaying performance related data. In some embodiments, it is envisaged that forecast performance data may also be included.

In the preferred embodiment, wherein the modular devices are electrolysers, it is envisaged that the system will further comprise any of the following: means for storing hydrogen, means for drying hydrogen, hydrogen refuelling stations, a fuel cell or other device/process requiring hydrogen.

Power balancing means, preferably fast acting power balancing means are provided. In the event an excess of power is supplied a power sink may be provided to protect the components.

Means for measuring output of each electrolyser and computing means for predicting said output based on a supply of power may also be used to control the system and loads within said system. For example, if an electrolyser is producing less than the expected amount of hydrogen for a given power supply, this implies an issue with that stack. An additional control device such as PID controller may be employed.

The optional features disclosed for the system embodiments described above may be included and controlled by the method of operating such a microgrid substantially as described above.

The available power from the primary source can be calculated as follows:

Power available=output from primary source×efficiency of transmission

It should be noted that the efficiency of transmission also accounts for the efficiency of inversion, should it be required such as DC/AC, or vice versa.

In order to better control the distribution of power to a plurality of electrolytic cells, it is envisaged that forecasting of power output from the one or more power sources may be performed. Where renewable sources are used, this could involve analysis of weather forecasts, with machine learning employed to correlate such forecasts to actual available power. Additionally, in an embodiment wherein PV panels are used, should output drop during daylight hours it may be possible to attribute this to passing clouds. Optical sensors, or even user input may be used to inform the system. In such instances a temporary reduction as opposed to transitioning to standby mode may be preferred.

It is envisaged that alternative power sources may be employed to allow for the operation of the bank of primary loads i.e. the electrolysers to allow for continued production of hydrogen, or equivalent output.

It is envisaged that the alternative load may be a battery bank, which can also be used as a buffer to ensure a smooth, relatively consistent power supply. Alternatively, appliances or devices in the microgrid may be alternative loads such as air conditioning, refrigeration, lights and more. Yet another alternative load could be a connection to a larger grid, or other micro-grid to allow for the maximisation of use of product.

By regularly measuring the available power it will occur that the power available is not sufficient to power the same number of electrolysers at the same capacity. The WRT or equivalent can then be used to reallocate power and ramp up or down loads as appropriate. If a forecast indicates that the change is short term then secondary loads or power sinks may be utilised. Such an approach helps to minimize cycling on and off of devices, which helps to increase their longevity.

Other methods of determining a stack's State of Health (SoH), a supplement or alternative to the WRT, generally include fitting the stack to an equivalent circuit model. In the simplest cases said model including resistor and capacitor components, but generally also adapted to include mass transport contributions as well. An example being Randles circuit, which includes a Warburg element to represent mass transport effects. Additionally, constant phase elements, a more general kind of capacitor element, to reflect porous electrodes may be included.

Equivalent circuit fitting of impedance spectra is possible for electrochemical stacks, but to obtain more useful data it is envisaged that fitting such a stack to equivalent circuits either requires electrochemical impedance spectroscopy (EIS) or another circuit through which the stack can passively charge/discharge. The passive charge/discharge circuitry having requisite switches and resistors to allow passive charging and discharging of the stack. Upon charging and discharging, the resulting voltage transience can be used, with a sufficient sampling rate, wherein said sampling rate is pre-determined, to fit the stack to an equivalent circuit. For the avoidance of doubt, the measured voltage transience may be combined with means for using said transience for fitting pre-determined equivalent circuit parameters. Characteristics of the stack voltage transience can be directly correlated with performance parameters that need to be identified (i.e. ohmic resistance, kinetic activity characteristics, and even mass transport/low frequency behaviour). This arguably increases the hardware complexity but allows for specific determination of parameters associated with individual cell components. EIS generally requires potentiostats which are expensive, however, one such potentiostat may be used to a plurality of electrolysers or strings of electrolysers. A DC bias is applied to the stack with an AC component (+/−1% of the DC bias) such that the frequency of the AC perturbation is swept from kHz to mHz—the impedance is measured at each frequency and this data can be used to fit the stack to an equivalent circuit model. If using a potentitostat, it would be connected to the electrochemical cell, stack or string by known means not described herein.

In another embodiment, the external dedicated passive discharge circuit can be fully bypassed, only using the discharging voltage transience of the electrolyser during shutdown via the power supply. The “idle” discharge profile of the stack is affected by many of the electrochemical observables stated prior, along with added information of potential gas or electrolyte leakages to the dry cathode. The existence of trace amounts of 02 in the primarily H2 line can show up as characteristic voltage responses, especially when one gaseous species is consumed to completion. Such a mixed potential is well known in the fuel cell community, but can be expanded to any catalytic layers that are at least partially active to both HOR and ORR. In this way, the quality of Hydrogen in the H2 gas processing line can be inferred, albeit indirectly so, in parallel with the electrochemical and mechanical sealing state of health of said electrolyser.

The ideal case, simplifying the hardware requirements while still obtaining useful information, involves simply looking at the changes in polarization curve data where the below equation separates the three dominating sources of losses: kinetic, ohmic, and mass transport.

$$V = {\underbrace{E}}_{OCV} - {\underbrace{b log ( \frac{i}{{i}_{0}} )}}_{Kinetic} - {\underbrace{i {R}^{′}}}_{Ohmic} + {\underbrace{a log ( 1 - \frac{i}{{i}_{lim}} )}}_{Transport}$$

Yet another diagnostic method includes measuring ΔV, or the change of polarization curve diagnostic. The polarization curve, or voltage versus applied current graph, gives us information of the different kinds of efficiency losses in an electrolyser cell/stack—kinetic, ohmic, and mass transport. Nominally, electrolysers are dominated by kinetic and ohmic losses, the former being a logarithmic V vs I relationship, and the latter being linear between V and I. Though mass transport losses are present in the worst cases, generally it can be taken as the difference between the raw polarization curve data and the kinetic+ohmic fitting data. The kinetic part having two fitting coefficients, these being Tafel slope and exchange current density, which are dependent on the electrochemical reactions of the cell and reflect the state of health of each electrode's catalyst layer. The ohmic part only has one fitting coefficient, this being DC resistance, factors impacting this including membrane state of health and increasing contact resistance due to corrosion. Lastly, mass transport generally has two fitting coefficients, a logarithm prefactor, and the limiting current density, both of which give us an idea of the degree of “resistance” of water getting to the catalyst layer and/or gases leaving the electrodes—mass transport losses mainly arise from the GDL, CL, and/or the membrane.

Consider that nonlinear curve fitting with five free parameters is practically rather difficult in our case and there are time constraints if done too regularly, although improved processing power may go some way to mitigating this—with an associated cost. Ignoring mass transport fitting now and focusing on the kinetic and ohmic allows for simplification. For the fitting procedure and improving accuracy and stability, the ohmic part may be measured and fixed such that the nonlinear curve fitting is only correcting for the two kinetic parameters in the first and only log term. In embodiments wherein one of the fitting parameters is stable, say the Tafel slope, this may be set at a fixed point in the control software/methodology reducing the variable. However, it is preferred to fix something that can be measured quickly such as the DC resistance or other suitable parameter. Deviation from the fitted polarization curve of purely ohmic+kinetic contributions with respect to the measured values can be attributed to mass transport limitation onset, which can also be used to properly define a maximum capacity value.

Some methods for measuring the ohmic part mentioned above include EIS or current interrupt which require a potentiostat or an impedance meter to read the impedance at a fixed high frequency (e.g. 1 kHz). As before a single potentiostat may be centralized and used for multiple stacks. It should be noted that distinguishing between a logarithm and a linear part of a curve is not easily done if there is not enough data, this is normally more pronounced at especially at a very low current density which require a long time to remove the capacitive contribution. It is envisaged that the means may be adapted to conduct more measurements at lower current densities to ensure adequate data, lower current densities being half or less than maximum operating capacity. Measuring the resistance by direct methods (e.g. EIS, current interrupt, impedance meter) removes this numerical issue allowing for a fast recording of the polarization curve, requiring less points for a accurate numerical fitting regardless of linear or logarithmic tendencies.

In a preferred embodiment of the present invention means are provided to create a polarization curve at pre-determined intervals such as every 1-1000 hours, 10-100 hours, 100-500 hours, or anywhere suitable within that range. Repeated creation of polarisation curves allows for time rates of change to be determined for each of the fitted voltage loss parameters for a given electrolyser module. With this knowledge, modules can be loaded with a corresponding weight factor in order to increase the lifetime of the aggregate system, in conjunction with catching individual module issues before catastrophic failure, as voltage gains in some cases start with reversible losses that eventually become irreversible. This data may be incorporated with the/a WRT to attribute a SoH.

For embodiments wherein the electrolytic cells are used to generate a product which is consumed, it is envisaged that the control means may be adapted to direct the requisite power to one or more of the cells at a rate to produce only what is to be consumed. This may be predetermined, input by a user or set by another mechanism. Alternatively, when the storage for the product is full, control means may facilitate the supply of power to generate no more than can be safely stored.

It is envisaged that demand side response (DSR) may be used in the event of unexpected power fluctuations. Such instances may result from damage to components, unexpected changes in weather conditions, or changing requirements of operating the electrolytic cells. Alternatives include utilising a power sink or other curtailing means.

There is an optional additional step of the above-described method wherein the collected data is made viewable to a user via a computing means connected to an app, web based or otherwise.

If demand for generated product surpasses that possible from the primary power, the control system may be configured to cause power from the alternative power source or battery bank to be directed as required, so as to supplement the primary power source. If there is no means to store the product, the available power can be routed to alternative loads including the battery bank, depending upon demand. Alternatively, if the battery or bank thereof is low then power may be redirected to it. It is envisaged that a predetermined threshold may be implemented to ensure that the batteries do not drop below a certain percentage charge (to increase their longevity) or a set amount of power as defined by the user or designer of the system.

This section outlines a specific example embodiment of a system in accordance with the present invention.

### Example Calculation of WRT Hours

Generally a basic WRT can be calculated using the basic formula of:

WRT=Percentage power×hours at said power

As an electrolyser may run with varied inputs, the calculation may have to be repeated for each steady state. Yet another option is to integrate to account for operation during ramp up and down of the electrolyser.

EL₁ Running at 100% for 100 hours−WRT=100 hours

EL₂ Running at 50% for 100 hours−WRT=50 hours

EL₃ Running at 30% for 200 hours−WRT=60 hours

Using WRT alone, in the above example Priority may be given to EL₂, having the lowest WRT despite having been operated half as many hours as EL₃ and for the same number of hours as EL₁. As an electrolyser may run at various load capacities for differing hours, the sum of these may be calculated.

The WRT may be further supplemented by the forecast means, and optionally a temperature sensor. Electrolysers need time to ramp up to be operational. It is not desirable for power to be wasted during this ramp up process, utilisation of temperature sensors allows for more accurate control by either providing heating where required and prioritising devices closer to the pre-determined operable range.

FIGS. 6A and 6B show schematically two examples of cells 60 which may be used in stack 50. Each type of cell 60 is bordered by a bipolar plate 61a and 61b. from the first bipolar plate 61a there is an anode 62, a membrane 64, a cathode 63 and the next bipolar plate 61b. In these figures the pins are not shown for the sake of clarity. The cell arrangement of FIG. 6B differs from that of FIG. 6A in that, between the bipolar plates 61a and the anode 62, there is a GDL (Gas Diffusion Layer) 65a. Additionally, there is another GDL 65b between the cathode 63 and second bipolar plate 61b.

FIG. 7 is a graph depicting the load curve of an electrolytic stack depicted in arrangements illustrated in the aforementioned Figures. The load ranges from 60% to 100% as it is here the relationship is seen to be linear and arguably most efficient. Loads of over 100% are not done in order to protect the stack. Loads under 60% are generally avoided due to the drop in efficiency.

Referring now to FIG. 8 shows an alternative arrangement for the power supply to the or each load. A notable difference here is the inclusion of a power sink 81. Power sinks are not preferred as the power sent there is wasted, which is clearly not ideal. Loads 82abc may be either electrolysers, or alternative loads. The control is not shown here.

Referring now to FIGS. 9A and 9B. The simple circuit as shown in FIG. 9A has two switches, S1 and S2, to passively charge or discharge a stack accordingly. Whilst these can be separate to a power supply or other components, a preferred circuit design is depicted in FIG. 9B. In the preferred circuit V_{charge} would simply be the power supply utilized by the electrolyser stack during normal operation, so only S2 would be required. In this case, the stack discharge alone is sufficient to establish a diagnosis of stack health. In diagnosis of electrochemical stacks such as fuel cells the passive charging is on the order of 100 mV with no gas flux such that no faradaic reactions occur—an equivalent for AEM water electrolysis at an intermediate temperature would be polarizing a stack to about 1-1.2V per cell such that electrolysis does not occur, though this voltage could be lowered to reduce time of acquisition and nonlinear effects. Either embodiment (i.e. either the circuit of FIG. 9A or 9B) may be used, however if the charging profile is deemed to be equally important for data analysis, then the circuit shown in FIG. 9A would be used.

The invention is not intended to be restricted to the details of the above described embodiment. For instance, any plurality of modular devices may be controlled in a manner as described in the above disclosed invention.

The present invention is not intended to be limited to AEM electrolysers, and other types of electrolyser may be used in a system according to the present invention.

Transformers may be used where required without deviating from the spirit of the present invention. As such they are not necessarily discussed in full as the individual of ordinary skill would be familiar with how to install them.

In the preferred embodiment, the electrolysers are AEM electrolysers. However, this is not necessarily intended as a limiting feature, as any bank of electrolysers may be controlled or used as disclosed herein.

1. A control system for a micro-grid comprising a plurality of electrolysers and one or more primary power sources, the control system being configured, under control of a processor, to:
determine power available from the one or more primary power sources; and generate control signals configured to cause available power to be directed to one or more of said plurality of electrolysers; wherein the control system is configured to be communicably connectable to in-situ diagnostic means associated with each of the electrolysers of said plurality of electrolysers for measuring a respective performance parameter, the control system being configured, under control of said processor, to receive signals from said in-situ diagnostic means and determine therefrom at least one performance parameter associated with said plurality of electrolysers.

2. A control system as claimed in claim 1, configured to derive any one or more of: polarisation curves; ohmic resistance, and; EIS using data received from said in-situ diagnostic means, preferably wherein the polarisation curves are generated at predetermined intervals.

3. (canceled)

4. A control system as claimed in claim 1, wherein each electrolyser is allocated unique identifier data.

5. A control system as claimed in claim 1, configured to obtain or determine any one or more of the following performance parameters from the in-situ diagnostic means in respect of each of one or more said plurality of electrolysers:
cumulative run time of each modular device,
cumulative down time of each modular device,
capacity at which the modular device has been run at whilst running,
Temperature of the device,
Pressure of the device,
Voltage/potential of the device, and
Data pertaining to the balance of plant such as
Electrolyte flow
electrolyte level
conductivity of said electrolyte
pump performance.

6. A control system as claimed in claim 1, wherein any one or more of the performance parameters is measured at predetermined intervals and/or upon a pre-determined trigger, preferably wherein a trigger includes one or both of a change of power supply and a forecast change of conditions.

7. (canceled)

8. A control system as claimed in claim 1, wherein each electrolyser has a Weighted Run Time (WRT) associated to it.

9. A control system according to claim 1, further configured, under control of the processor, to perform power balancing in respect of said plurality of electrolysers.

10. A control system as claimed in claim 1, configured to receive output signals from each of said plurality of electrolysers, and being configured, under control of the processor, to predict an output of each electrolyser and to compute a predicted output based on an allocated distribution of power to said plurality of electrolysers.

11. A microgrid comprising a plurality of electrolysers, one or more primary sources of power, in-situ diagnostic means associated with each of the electrolysers for measuring respective performance parameter, and a control system as claimed in claim 1, the control system being communicably connectable to the in-situ diagnostic means.

12. A microgrid as claimed in claim 11, wherein at least one of the primary power sources is a renewable energy source or a grid connection.

13. A microgrid as claimed in claim 11, additionally comprising one or more secondary power sources, preferably wherein at least one of the secondary power sources is a renewable energy source or a grid connection.

14. (canceled)

15. A microgrid as claimed in any of claim 11, wherein each electrolyser is an AEM electrolyser operating with a dry cathode.

16. A microgrid as claimed in claim 11, further comprising one or more alternative loads, preferably wherein the alternative load is any one or more of:
one or more batteries;
electrochemical energy storage devices;
capacitors;
appliances, or
grid.

17. (canceled)

18. A microgrid as claimed in claim 11, further comprising means, communicably coupled to the control system, for measuring the power available from the one or more primary power sources.

19. A microgrid as claimed in claim 11, wherein the one or more primary power sources comprise renewable energy sources, the microgrid further comprising forecasting means, communicably coupled to the control system, for forecasting the power expected to be available from the one or more primary power sources, preferably wherein the forecasting means comprise any one or more of:
Weather forecasting;
Windspeed forecasting;
Cloud cover; and
Tidal states.

20. (canceled)

21. A microgrid as claimed in claim 11, wherein the electrolysers are adapted to run at different capacities.

22. A microgrid as claimed in claim 11, wherein the electrolysers have passive charge/discharge circuitry for use by the in-situ diagnostic means for measuring respective voltage transience and include means for using said transience for fitting pre-determined equivalent circuit parameters.

23. A microgrid as claimed in claim 11, wherein the power from the one or more primary power sources is AC or DC, and the one or more electrolysers are powered by either AC or DC.

24. A microgrid as claimed in claim 11, including means for the handling and use of hydrogen output from said electrolysers, such as a dryer, hydrogen storage means or a fuel cell.

25. A method for operating/controlling a bank of electrolytic cells, the electrolytic cells and other components forming a micro-grid, the method comprising the following steps:
allocating a unique identifier to each of the one or more electrolytic cells, said electrolytic cells being the primary load for the microgrid; and, at intervals repeating the steps of:
determining/estimating power output from one or more sources of power;
determining which and how many of the electrolytic cells are available for operation;
determining a set point for the or each available electrolytic cell;
directing said power to one or more electrolytic cells, and monitoring the activity of each of the electrolytic cells;
measuring in-situ diagnostic data and logging the results in association with unique identifier data for each electrolytic cell;
measuring actual power output and comparing it to expected power output; and
repeating the above steps at regular pre-determined intervals, and reducing a set point of one or more of said electrolytic cells in the event that power output is insufficient or operation of one or more of the electrolytic cells is not required.
